(19) United States
(12) Patent Application Publication
(10) Pub. No.: US 2014/0299795 A1
(43) Pub. Date: Oct. 9, 2014

(54) SHIELDED HEAD COVER WITH VARYING ATTENUATION PORTIONS

(71) Applicant: Todd J. COHEN, Mineola, NY (US)

(72) Inventor: Todd J. COHEN, Mineola, NY (US)

(21) Appl. No.: 14/263,754

(22) Filed: Apr. 28, 2014

Related U.S. Application Data
(63) Continuation of application No. 12/776,563, filed on May 10, 2010, now abandoned.

(51) Int. Cl. G21F 3/02; A42B 1/00

(52) U.S. Cl. CPC G21F 3/02; A42B 1/008
USPC 250/516.1; 427/2.1

(57) ABSTRACT

A shielded head cover in accordance with an embodiment of the present application includes at least one attenuation portion including a radiation attenuating material configured and operable to protect a user head from radiation. The attenuation portion includes a varying amount of radiation attenuating material at different locations to provide for increased protection at desired locations. The attenuation portion may be embodied as a removable patch that is attached to the head cover. The attenuation portion may be provided by spraying particles of radiation attenuating material on the head cover.

### BACKGROUND

1. Field of the Disclosure

The present disclosure relates to a radiation-shielded garment for use on a person's head. More specifically, the present disclosure relates to a shielded head cover including at least one radiation attenuation portion, the radiation attenuation is provided in a variable manner such that maximum protection is provided in desired areas and reduced protection is provided in other areas.

2. Related Art

Cardiologists, radiologist, surgeons, and other individuals may use x-ray equipment, which emits radiation in order to visualize bodily structures and perform procedures. Some examples of these types of procedures are 1) cardiac catheterization procedures including coronary angiography/percutaneous coronary interventions, 2) implantation of pacemakers and defibrillators, and 3) interventional radiology procedures.

Operators involved in these procedures are exposed to cumulative radiation via direct and even more importantly scatter radiation. Radiation sensitive tissue is shielded through the use of hanging shields, and operators and/or their assistants wear lead or lead-like (defined as other materials besides lead which impede and/or block the radiation penetration) aprons including thyroid shields and perhaps even lead glasses to minimize exposure. Lastly, drapes, which are placed over or on the side of a patient, have been used as barriers as well. Lead is an effective radiation attenuating substance, however, is rather heavy. Thus, one problem with providing garments with radiation shielding is that they tend to be heavy. This increased weight not only reduces comfort but can substantially physically tax a user, particularly during a long operation or procedure.

In certain procedures, such as the implantation of pacemaker type devices, it is difficult to place a shield between the operator and the x-ray equipment due to the close proximity of the imaging site and the field of manipulation. Longer more complicated procedures such as the implantation of biventricular devices and/or revision may take hours and provide unabated radiation/scatter exposure.

Most direct interventionalists who work in a room like a catheterization laboratory or electrophysiology laboratory often receive little or no protection from scatter radiation to the brain (other than the barriers previously described). Therefore, there is a need for additional protection to these operators and perhaps the other assistants who may also be exposed.

Radiation sensitive tissue include but are not limited to gonadal and mammary tissue, bone marrow, the eyes, lungs, thyroid and brain. There is no common wearable shield for the latter structure. And brain cancer, is a very problematic illness if it occurs.

Accordingly, it would be desirable to provide a garment that provides radiation attenuation to avoid the problems described above.

### SUMMARY

It is an object of the present invention to provide a shielded garment that protects the head from radiation to a varying degree based on exposure and sensitivity to radiation.

It is another objective of the present invention to provide radiation barrier protection in the form of a surgical hat, cap, cloth, or helmet suitable to be worn on the head to keep hair under cover and provide shielding to the brain. Using lead or more preferably lead-like materials (often lightweight) an adjustable head cover is provided. Typically these lead-like materials provide 90-95% protection from radiation exposure.

It is another object of the present invention to provide protection when undergoing other radiologic procedures including radiation therapy, brachytherapy, and other procedures such as CT Scans, cineangiography and fluoroscopy.

A head cover in accordance with an embodiment of the present application includes including a radiation attenuating portion configured and operable to protect a user head from radiation, the attenuation portion including a varying amount of radiation attenuating material at different locations to provide for increased protection at desired locations.

A method of applying radiation attenuating material to a head cover in accordance with an embodiment of the present application includes combining particles of radiation attenuating material with adhesive, spraying the particles of radiation attenuating material and adhesive onto the head cover and spraying more particle of radiation attenuating material on the head cover at desired locations where increased radiation protection is desired.

Other features and advantages of the present invention will become apparent from the following description of the invention, which refers to the accompanying drawings.

### BRIEF DESCRIPTION OF THE DRAWINGS

FIG. 1 illustrates an exemplary embodiment of a shielded head cover in accordance with an embodiment of the present application.

FIG. 2 illustrates an exemplary embodiment of a shielded head cover in accordance with another embodiment of the present application.

FIG. 2A illustrates an exemplary embodiment of shielded head cover in accordance with an embodiment of the present application.

FIG. 3 illustrates an exemplary embodiment of a removable patch suitable for use in the head cover of FIG. 2.

FIG. 4 illustrates a cross sectional view of an exemplary embodiment of a removable patch suitable for use in the head cover of FIG. 2.

FIG. 5 illustrates an exemplary embodiment of a shielded head cover in accordance with an embodiment of the present application.

FIG. 6 illustrates an exemplary embodiment of a shielded head cover in accordance with another embodiment of the present application including an additional radiation shield element attached thereto.

FIG. 7 illustrates an exemplary embodiment of a shielded head cover in accordance with an embodiment of the present application.

FIG. 8 illustrates an exemplary embodiment of a shielded head cover in accordance with another embodiment of the present application.

FIG. 9 illustrates an exemplary embodiment of a shielded head cover in accordance with an embodiment of the present application.

### DETAILED DESCRIPTION OF THE EMBODIMENTS

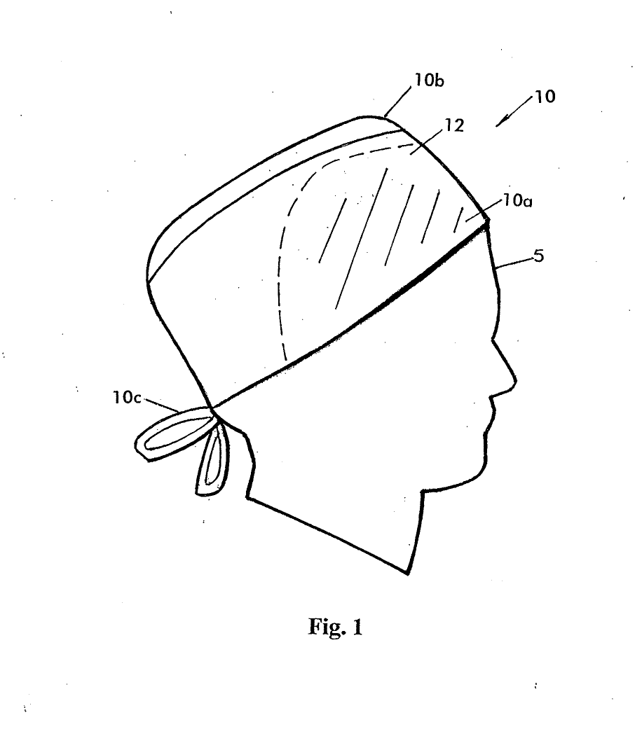

FIG. 1 illustrates an exemplary embodiment of a head cover 10 on the head of a user 5 in accordance with an embodiment of the present application. The head cover 10 includes at least one attenuation portion 12 that includes radiation attenuating material to protect the user's head from radiation.

In a preferred embodiment, the amount of radiation attenuating material of the attenuation portion 12 varies depending on the level of desired radiation protection. For example, the attenuation portion 12 may provide additional radiation material and consequently additional radiation protection for areas around the head that are at risk of additional exposure to radiation or which are particularly sensitive to radiation. The attenuation portion 12 may also provide less radiation material and consequently less radiation protection for areas of the head that are at risk of lower radiation exposure or that are less sensitive to radiation. The areas requiring more protection may be determined based on statistical analysis of radiation backscatter based on the source, for example.

The radiation attenuation portion 12 may be grooved, or the shape of the radiation attenuation portion can be made irregular and/or asymmetric to provide varying degrees of radiation protection, although any of the known methods can be employed to achieve this result. In this manner, areas of the head that are exposed to more radiation or that are particularly sensitive to radiation are provided with additional protection from radiation, while other areas are provided with less protection.

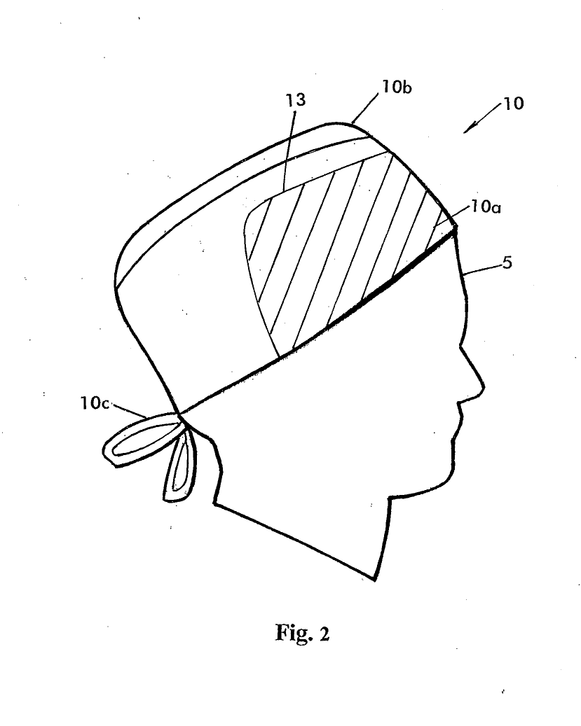

In a preferred embodiment, to cover more of the cover 10 with radiation attenuating material, the cover 10 can include one large radiation attenuation portion 12, or a plurality of smaller radiation portions 12. See FIG. 2A, for example. Preferably, the radiation attenuating material of each attenuation portion 12 may be constructed to provide a specific degree, or even varying degrees, of radiation protection depending on the area, or areas, of the head that need radiation protection.

Varying the amount of radiation attenuating material to vary radiation protection also serves to reduce overall weight of cover 10. As noted above, radiation attenuating materials can be relatively heavy. Varying the amount used allows for maximum protection in desired areas while overall minimizing weight of the cover 10. This is particularly useful since surgeries and other procedures can take several hours and the more weight the user is forced to support on his head, the more likely it is that fatigue will set in, especially in the area of the neck and back.

The radiation attenuating material may be any suitable material that provides protection from radiation. The most common example of such a radiation attenuating material is lead, however any material that blocks or partially blocks radiation may be used. It is preferred that a relatively lightweight radiation attenuating material is used in order to increase comfort for the user. The radiation attenuating material may be lead or a lead-like substance. Despite lead's weight, lead shielding which is relatively thin and lightweight can be provided. The radiation attenuating material may include a single material or an admixture of different materials that block or partially block the penetration of radiation. Radiation attenuating materials include, but are not limited to lead, bismuth, antimony and tungsten. The radiation attenuating material may also include combinations of lead and other nonlead radiation attenuating materials.

Generally, the cover 10 includes a base section 10a that essentially wraps around the user's head and a top section 10b covering the top of the user's head. The cover 10, preferably also includes a fastener 10c of some sort to allow it to be fastened to the users head. In FIG. 1, the fastener 10c is illustrate as a tie string, however, any suitable fastener may be used. While the attenuation portion 12 of the cover 10 which includes the radiation attenuating material is shown as extending on one side of the user's head in FIG. 1, this area may extend substantially the same amount around the other side of the user's head as well, or to any part of the cover 10, as may be necessary to provide a desired level of radiation protection.

While the surgical cap type cover 10 is shown to be in the form of a known surgical cap, it may be in the form of any suitable head cover, including but not limited to a hat, helmet, or headband for example.

In an alternative embodiment, the attenuation portion 12 of the cover 10 is a removable patch 13, FIG. 2. The patch 13 may be similar in design to an adhesive bandage with an adhesive on a first side thereof facing the cover 10 to adhere the patch 13 to the cover. Alternatively, the patch 13 may include adhesive on the ends thereof only to attach the patch 13 to cover 10. While illustrated as being attached to the outer surface of the cover 10, the patch 13, may be attached to the inner surface of the cover, if desired.

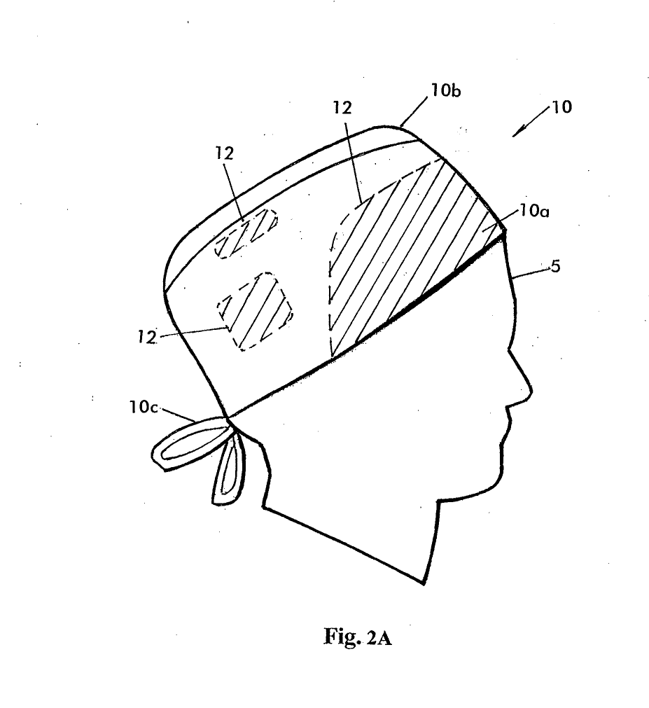

FIG. 3 illustrates the patch 13 removed from the cover 10. As illustrated in FIG. 3, the patch 13 may be substantially rectangular in shape, however, any desired shape may be used as desired or appropriate to provide protection to those portions of the head that are exposed to radiation the most or that are particularly sensitive to radiation. For example, a curvilinear, oval or hourglass shaped patch 13, may be used. The shape of the patch 13 may also be based on the type of radiation used, and/or the backscatter pattern anticipated in the particular procedure.

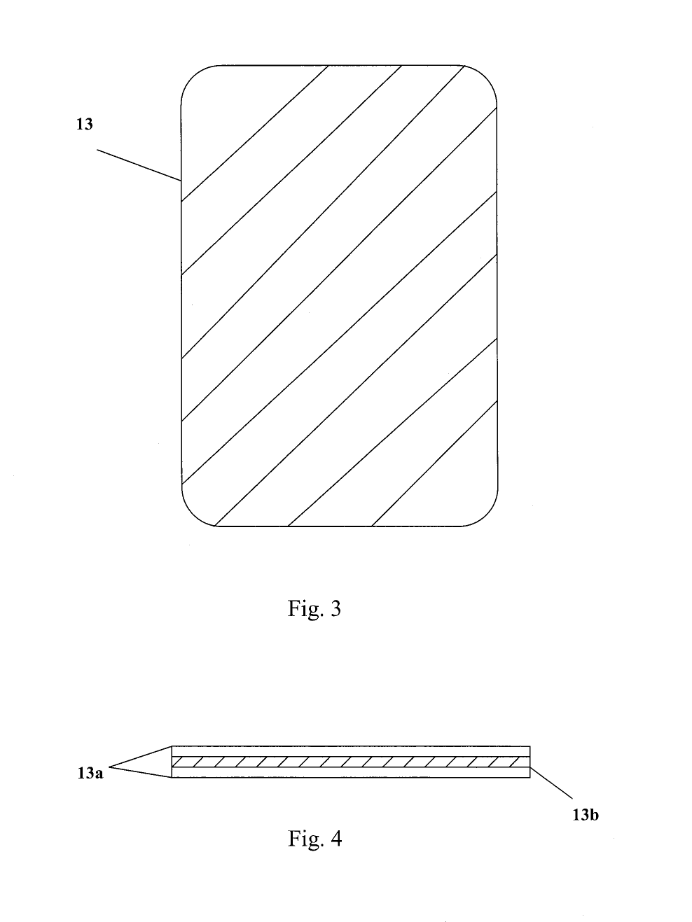

In another embodiment, the patch 13 may be similar to a surgical bandage with a layer of the radiation attenuating material positioned between 2 layers of hypoallergenic tape to hold it in place. See FIG. 4, for example, where the two layers of tape 13a, 13b surround the radiation attenuating material 13b.

In another embodiment, the patch 13 may be in the form of an insert. In this embodiment, a pouch, or pocket, is preferably formed in the in the cover 10 that is sized to receive the insert patch 13. The pouch or pocket may be formed on the inner or outer side of the cover 10. Alternatively, the patch 13 may be fastened to the cover 10 in any desired manner, for example using hook and loop type fasteners.

The patch 13 may be of any desired size or shape. For example, a 4 inch by 6 inch or 10 inch by 30 inch patch 13 would allow for the patch to wrap around a substantial portion of the cover 10. Adhesive may be provided along the length of the patch 13 or just at the ends thereof as noted above.

The shape of the patch 13 may be grooved, irregular and/or asymmetric similar to the attenuation portion 12 discussed above, to provide different levels of radiation protection at different areas of the head. As is noted above, this allows areas of the head that are exposed to more radiation or that are particularly sensitive to radiation to be provided with additional protection from radiation, while other areas are provided with less protection. Higher amounts of radiation attenuating material could be provided on the patch 13 in desired areas, as well, to vary protection. In addition, multiple patches 13 could be applied to the cover 10 with a varying amount of radiation material included thereon to vary protection for the different areas of the head. The radiation attenuating material used in the patch 13 is preferably similar to that used in the radiation attenuation portion 12 discussed above.

In another embodiment, the cover 10 may be rotated, or otherwise repositioned on a user's head to shift the position of the attenuation portion 12 as conditions change. For example, during the course of a procedure, the wearer may move their head, or the source of radiation may be moved. In this case, the cover 10 may be rotated on the user's head, or otherwise repositioned in order to provide the attenuation portion 12 in a desired position.

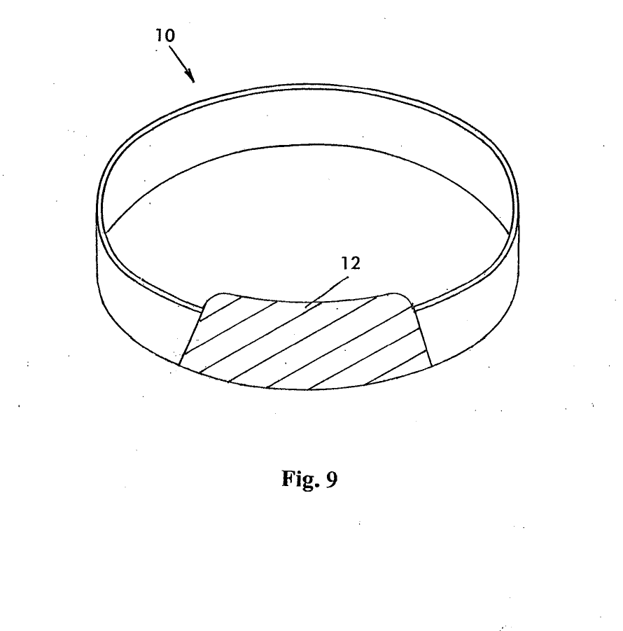

In one embodiment, the cover 10 may be in the form of a headband, as illustrated in FIG. 9, for example. While FIG. 9 illustrates an exemplary embodiment of a headband, the present application is not limited to the specific illustration therein. The headband 10 may be of any desired width. The headband 10 is preferably lightweight and adjustable for comfort on the user's head. In this embodiment, the attenuation portion 12 may be positioned on the front of the headband 10, as shown in FIG. 9, or in any desired position, and may have any desired shape. As a user, or radiation source, moves during a procedure, for example, the headband 10 may simply be rotated as desired to position the attenuation portion 12, as desired. The headband configuration of FIG. 9 can be used in conjunction with a standard, non-shielded surgical cap, if desired. That is, a standard cap may be placed over, or under, the headband 10, while still allowing for the headband 10 to be rotated to reposition the attenuation portion 12. The attenuation portion 12 may include a patch 13 as described above.

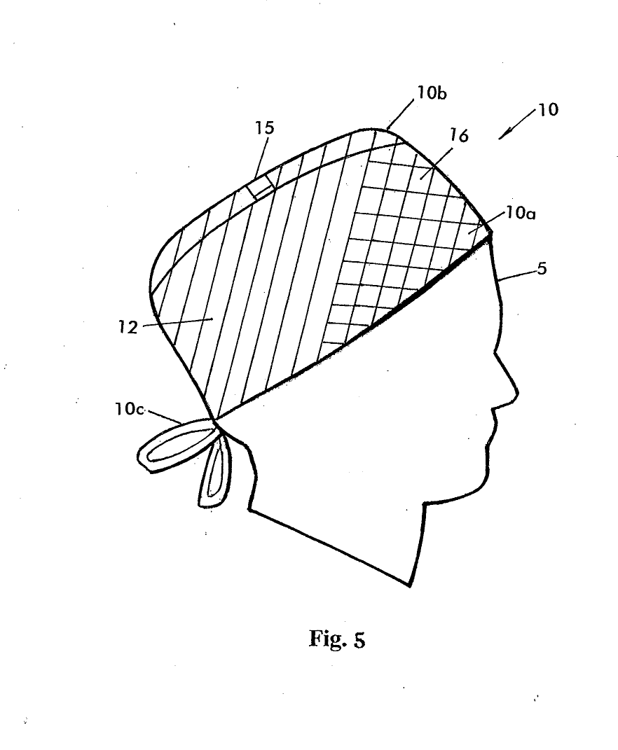

In another embodiment, the radiation attenuating material may be applied to the cover 10 as a spray on covering. See FIG. 5. That is, particles of radiation attenuating material may be sprayed onto the cover 10. In this embodiment, an adhesive material is preferably mixed in with particles of the radiation attenuating material to help them adhere to the cover 10. Additional radiation attenuating material may be sprayed onto the cover 10 in those areas that require more protection. The placement of additional radiation attenuating material may be determined based on statistical analysis of radiation backscatter based on the source, as noted above.

Referring to FIG. 5, the radiation attenuating material may be sprayed to cover the entire cover 10 such that the attenuation portion 12 includes substantially the entire cover. The cover 10, however, may include areas of high concentration 16, indicated by cross-hatching in FIG. 5. The areas 16 generally correspond to those areas in which it is desirable to provide additional protection from radiation. In addition, there may be areas of the cover 10 on which lesser or no radiation attenuating material is applied at all. In such areas, a vent 15 may be provided to allow for cooling of the user's head.

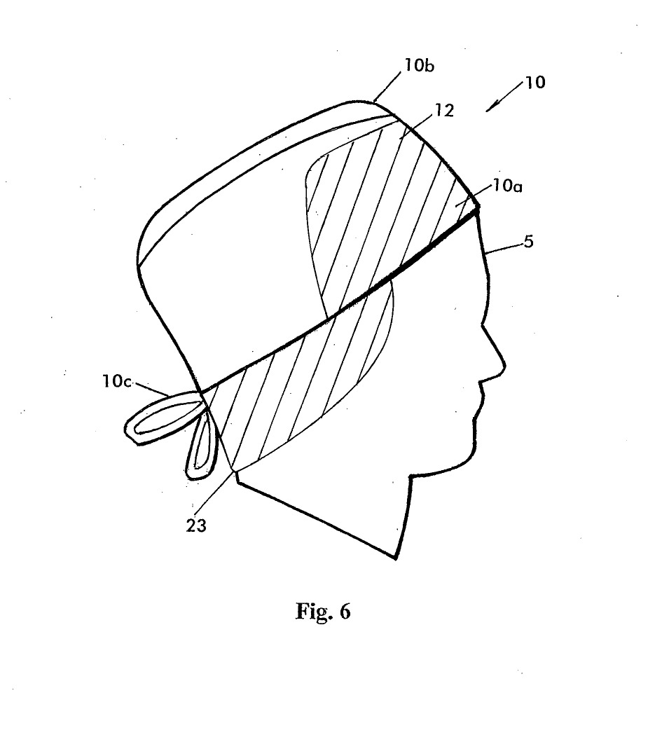

In another embodiment, additional patches, or shields 23, may be attached to the cover 10 to extend protection, for example, down the neck, or anywhere else that it is desired. See FIG. 6, for example. These shields 23 similarly may have an uneven or grooved structure to provide additional radiation attenuating material in desired locations to increase protection. These shields may be clipped or otherwise fastened to the cap 10, preferably at the lower edge thereof. The shields 23 may be shaped as desired and may include varying amounts of radiation attenuating material to provide for additional protection in desired areas, and less protection in other areas as desired as well.

If desired, a radiation monitoring element may be provided on the cover 10. The radiation monitoring element may be provided on the inside cover, outside cover, or anywhere desired to track radiation exposure. In a preferred embodiment, the radiation monitoring element is provided on the inside of the cover 10 to track the amount of radiation that is penetrating the cover and to which the user is exposed. The radiation monitoring element may take the form of a common radiation exposure badge, or similar device, as desired.

The cover 10 of the present disclosure may be washable either with, or without, the patch 13, or the shield 23. The patch 13 and shield 23 may be reusable, or disposable as desired. Similarly, the cover 10 may be disposable or reusable as desired.

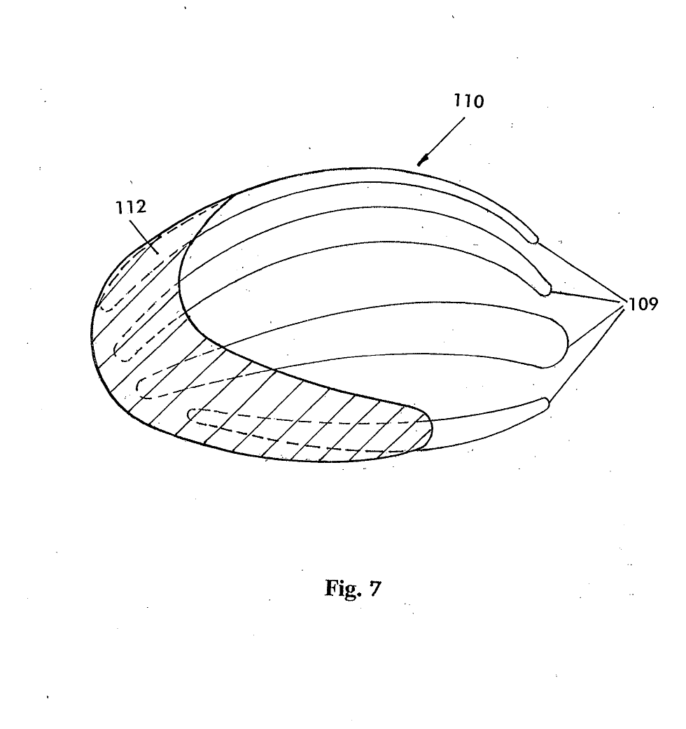

In another embodiment, a cover 110 may include a semi-rigid frame 109 (See FIG. 7) over which a sheet, or sheets, 112 of material including radiation attenuating material are stretched. The amount of radiation attenuating material in the sheets may be varied to provide increased protection in areas requiring it as noted above. The remainder of the frame may be covered with a breathable material to allow for ventilation. As can be seen in FIG. 7, this embodiment is similar to a bicycle helmet.

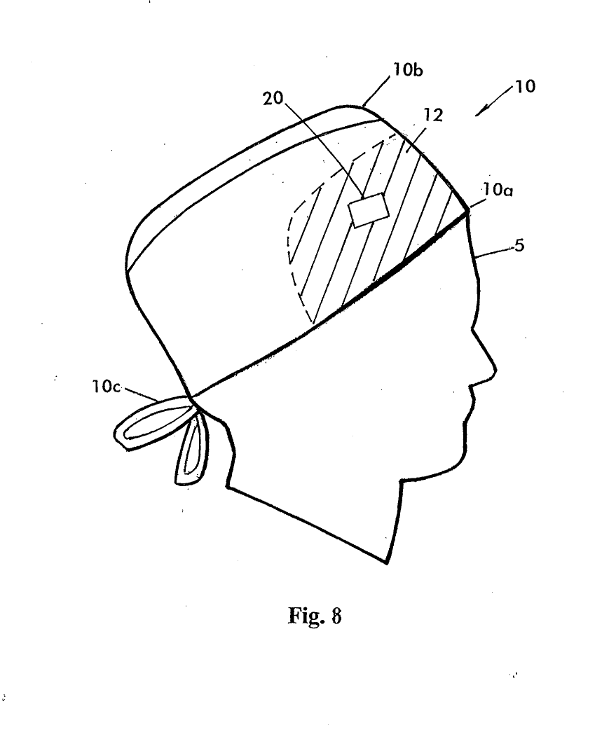

In another embodiment, illustrated in FIG. 8, for example, the cover 10 may include an opening 20 in the attenuation portion 12. In this manner, the cover 10 may be used on patients receiving focused radiation treatment while providing protection to the rest of the head.

Although the present invention has been described in relation to particular embodiments thereof, many other variations and modifications and other uses will become apparent to those skilled in the art.

What is claimed is:

1. A shielded head cover including at least one attenuation portion including a radiation attenuating material configured and operable to protect a user head from radiation, the attenuation portion including a varying amount of radiation attenuating material at different locations to provide for increased protection at desired locations.

2. The shielded head cover of claim 1, wherein the attenuation portion is asymmetrically shaped such that additional protection is provided to the desired locations.

3. The shielded head cover of claim 1, wherein the attenuation portion comprises a removable patch that is attached to the head cover.

4. The shielded head cover of claim 3, wherein an amount of radiation attenuating material in the removable patch varies to provide for increased protection at the desired locations.

5. The shielded head cover of claim 4, wherein the removable patch further comprises:
a first strip of hypoallergenic tape;
a second strip of hypoallergenic tape; and
a strip of radiation attenuating material positioned between the first and second strips of hypoallergenic tape and held in place by the first and second strips of hypoallergenic tape.

6. The shielded head cover of claim 4, wherein the removable patch further comprises adhesive positioned on at least one side of the removable patch to attach the removable patch to the head cover.

7. The shielded head cover of claim 4, wherein the removable patch further comprises:
a first end;
a second end position opposite the first end, and
adhesive provided at the first and second ends of the removable patch to attach the removable patch to the head cover.

8. The shielded head cover of claim 4, wherein the shielded head cover further comprises a recess configured and operable to received the removable patch.

9. The shielded head cover of claim 4, wherein the removable patch is substantially rectangular in shape.

10. The shielded head cover of claim 4, wherein the removable patch has a curvilinear shape.

11. The shielded head cover of claim 1, wherein the attenuation portion comprises a layer of particles of radiation attenuating material and adhesive sprayed onto the head cover.

12. The shielded head cover of claim 12, wherein a higher number of particles of radiation attenuating material are sprayed in the desired locations to provide additional protection.

13. The shielded head cover of claim 1, further comprising a shield element including radiation attenuating material, the shield element configured and operable for attachment to an edge of the head cover to extend radiation protection.

14. The shielded head cover of claim 13, wherein an amount of radiation attenuating material in the shield element varies based on location to provide additional protection at high risk locations.

15. The shielded head cover of claim 2, wherein the head cover is configured and operable to be rotated on a head of the user to change the position of the attenuation portion.

16. The shielded head cover of claim 15 wherein the shielded head cover is a headband.

17. A method of applying radiation attenuating material to a head cover comprises:
combining particles of radiation attenuating material with adhesive;
spraying the particles of radiation attenuating material and adhesive onto the head cover; and
spraying more particle of radiation attenuating material on the head cover at desired locations where increased radiation protection is desired.

18. The method of applying radiation attenuating material of claim 17, further comprising identifying the desired locations based on statistical analysis of backscatter associated with a specific radiation source in use.
